(19) United States
(12) Patent Application Publication
(10) Pub. No.: US 2004/0090526 A1
(43) Pub. Date: May 13, 2004

(54) Image management apparatus, imaging apparatus, and image storage management system

(75) Inventors: Mikio Watanabe, Asaka-shi (JP); Hiroshi Tanaka, Asaka-shi (JP)

Correspondence Address: McGinn & Gibb, PLLC, 8321 Old Courthouse Road, Suite 200, Vienna, VA, 22182-3817, US

(73) Assignee: Fuji Photo Film Co., Ltd., Minamiashigara-shi (JP)

(21) Appl. No.: 10/608,093

(22) Filed: Jun. 30, 2003

(30) Foreign Application Priority Data
Jun. 28, 2002 (JP) 189478/2002

(51) Int. Cl. H04N 5/225

(52) U.S. Cl. 348/207.1

(57) ABSTRACT

Images of a predetermined location such as a construction site can be obtained easily. Photography instruction information including sketches of spots to be photographed, the names of the spots, and a process number is sent from an image management apparatus to a digital camera for photography of the images necessary for process management regarding the site. The digital camera sequentially displays the sketches and the names of the spots included in the photography instruction information on a monitor, and photographs the spots according to the sketches and the names. Image data sets obtained by photography are sent to the image management apparatus via a wireless LAN. The image management apparatus manages the site based on the image data sets sent from the digital camera.

### BACKGROUND OF THE INVENTION

1. Field of the Invention

The present invention relates to an image management apparatus for managing images representing progress at a construction site or the like, an imaging apparatus for obtaining the images managed by the image management apparatus, and an image storage management system comprising the image management apparatus and the imaging apparatus.

2. Description of the Related Art

Construction sites for buildings and the like are often remote from offices that manage construction, and one office usually manages a plurality of construction sites. For this reason, in order to efficiently carry out construction site management by an office, a system has been proposed wherein a TV camera is installed at a construction site and image data representing an image obtained by the TV camera are sent via a wireless communication network from the construction site to a management apparatus installed in the office remote from the site (Japanese Unexamined Patent Publication No. 9(1997)-261619).

Furthermore, another system has also been proposed for efficient management of a construction site (Japanese Unexamined Patent Publication No. 2001-24982). In this system, photography information representing a photography location and the like is sent from a computer to a digital camera, and the digital camera photographs a construction site based on the photography information. Image data obtained by the digital camera are input to a computer wherein an image database is generated for image search using the photography information as a keyword, for example.

Still another system has also been proposed with use of a digital camera that can send image data obtained by photography via a wireless communication network (European Patent Publication No. EP 0 991 260 A2). In this system, a state of storage of the image data in a memory is managed and the image data are sent to a predetermined addressee via the wireless communication network according to a result of the management.

However, in the system described in Japanese Unexamined Patent Publication No. 9(1997)-261619, a plurality of TV cameras need to be installed at all spots in the case where one office in a construction site manages all the spots. Therefore, the system requires heavy investment in equipment.

In the system described in Japanese Unexamined Patent Publication No. 2001-24982, an image of a spot can be obtained without heavy equipment investment as long as the photography information is sent to the digital camera. However, if the photography information is not sent to the digital camera, the image cannot be photographed.

In the system described in European Patent Publication No. EP 0 991 260 A2, the image data obtained at any arbitrary spot can be sent. However, since only the image data photographed according to discretion of a photographer can be sent, the photographer needs to memorize all spots to be photographed in the case of construction site management. Therefore, a workload of the photographer is heavy.

### SUMMARY OF THE INVENTION

The present invention has been conceived based on consideration of the above circumstances. An object of the present invention is therefore to enable easy acquisition of an image of a predetermined photography location such as a construction site.

An image management apparatus of the present invention comprises:

photography instruction information storage means for storing photography instruction information that indicates a subject to be photographed;

communication means for sending the photography instruction information to an imaging apparatus via a wireless communication network and for receiving information transmitted via the wireless communication network;

input means for receiving an input of image data obtained by the imaging apparatus according to the photography instruction information; and

storage means for storing the image data.

The photography instruction information includes information on a photography process representing the type of the subject to be photographed and a deadline for obtaining the image data. More specifically, the photography instruction information may include information that can specify the subject to be photographed, such as a sketch representing only an outline of the subject or information comprising characters representing a photography location, in addition to code information representing the subject type, and a number representing a construction process, for example. The imaging apparatus may store the code information in relation to the sketch. In this case, the photography instruction information comprising the code information is sent from the image management apparatus of the present invention to the imaging apparatus so that photography can be carried out with reference to the sketch corresponding to the code information displayed on the imaging apparatus.

The wireless communication network refers to a network that enables data communication by radio. More specifically, the wireless communication network refers to a wireless LAN communication network, a cellular phone network, or a short-range wireless communication network using Bluetooth, for example. The wireless communication network in the present invention refers to not only the case where an entire network connecting the imaging apparatus and the image management apparatus of the present invention comprises the wireless communication network but also the case where a portion of the network comprises the wireless communication network.

In the image management apparatus of the present invention, the input means may be means for receiving the input of the image data sent from the imaging apparatus via the wireless communication network.

The image management apparatus of the present invention may further comprise communication control means for comparing the image data stored in the storage means with the photography instruction information stored in the photography instruction information storage means, and for controlling the communication means so that the photography instruction information is sent again to the imaging apparatus in the case where the storage means does not have the image data corresponding to the photography instruction information.

In the case where the imaging means did not photograph an image corresponding to the photography instruction information sent thereto, the storage means lacks the corresponding image data. However, even in the case where the image was photographed, the image represented by the obtained image data may not have a predetermined quality due to camera shake, inappropriate focus, or underexposure, for example. In the present invention, the image data corresponding to the image are thought to be lacking in the case where the obtained image does not have the predetermined image quality.

In the image management apparatus of the present invention, the photography instruction information may include at least position information representing a position of the subject.

The image management apparatus of the present invention may further comprise:

position detection means for detecting a position of the imaging apparatus so that

the communication control means can control the communication means to send to the imaging apparatus the photography instruction information corresponding to the position of the imaging apparatus.

An imaging apparatus of the present invention comprises:

imaging means for obtaining image data representing a subject by photography of the subject;

reception means for receiving the photography instruction information from the image management apparatus of the present invention;

display means for displaying information including the photography instruction information; and

storage means for storing the image data obtained by the imaging means according to the photography instruction information.

The imaging apparatus of the present invention may further comprise transmission means for sending the image data stored in the storage means to the image management apparatus of the present invention via the wireless communication network.

The imaging apparatus of the present invention may further comprise:

position information obtaining means for obtaining position information representing a position of the imaging apparatus; and

transmission control means for controlling the transmission means to send the position information to the image management apparatus of the present invention.

An image storage management system of the present invention comprises the image management apparatus of the present invention and at least one imaging apparatus of the present invention.

According to the present invention, the photography instruction information representing the subject to be photographed is sent to the imaging apparatus via the wireless communication network, and the imaging apparatus that receives the photography instruction information obtains the image data by carrying out photography according to the photography instruction information. The image data are received by the input means of the image management apparatus and stored in the storage means.

As has been described above, the photography instruction information representing the subject to be photographed is sent to the imaging apparatus. Therefore, installation of imaging apparatuses at all locations of subjects becomes unnecessary. In this manner, photography of the subject can be carried out at all locations in a construction site or the like, with less equipment investment. Furthermore, by carrying out photography according to the photography instruction information with use of the imaging apparatus, a photographer does not need to memorize the locations to be photographed. In this manner, a workload of the photographer can be reduced. Moreover, since the photography instruction information is sent to the imaging apparatus via the wireless communication network, the image of the subject can be photographed by sending the photography instruction information even if the imaging apparatus is remote from the image management apparatus.

According to one aspect of the present invention, the image data are received via the wireless communication network from the imaging apparatus having the transmission means therefor. If the image data are received from the imaging apparatus via the wireless communication network, the image data obtained at the photography location can be stored immediately in the storage means.

According to another aspect of the present invention, the image data stored in the storage means are compared to the photography instruction information stored in the photography instruction information storage means. In the case where the storage means lacks the image data corresponding to the photography instruction information, that is, in the case where the image data whose photography was instructed by the photography instruction information are not stored in the storage means, the photography instruction information corresponding to the lacking image data is sent again to the imaging apparatus. The imaging apparatus can photograph the subject based on the photography instruction information sent again thereto, and obtains the image data corresponding to the photography instruction information. In this manner, all the image data corresponding to the photography instruction information can surely be stored in the storage means.

According to still another aspect of the present invention, the position information representing the position of the subject is included in the photography instruction information. Therefore, by referring to the photography instruction information, the position of the subject can be known easily, and the imaging apparatus can easily obtain the image data corresponding to the photography instruction information.

According to yet another aspect of the present invention, the position detection means can detect the position of the imaging apparatus, and the photography instruction information corresponding to the position is sent to the imaging apparatus. Particularly, if the imaging apparatus itself can obtain the position information by using the position information obtaining means and can send the position information to the image management apparatus, the image management apparatus can easily know the position of the imaging apparatus. In this manner, in the case where a plurality of imaging apparatuses of the present invention are used, the photography instruction information that instructs photography of the subject can be sent to one of the imaging apparatuses close to the position of the subject. Therefore, the imaging apparatus can efficiently photograph the subject, and the image data are obtained efficiently.

### BRIEF DESCRIPTION OF THE DRAWINGS

FIG. 1 is a block diagram showing a configuration of an image storage management system comprising an image management apparatus and an imaging apparatus as a first embodiment of the present invention;

FIG. 2 is a diagram showing an example of site management information;

FIG. 3 shows a photography instruction image displayed on a monitor of a digital camera;

FIG. 4A and FIG. 4B show a flow chart illustrating the operation of the first embodiment;

FIG. 5 is a block diagram showing a configuration of an image storage management system as a second embodiment of the present invention;

FIG. 6 is a diagram for explaining photography instruction information sent to a digital camera in the second embodiment;

FIG. 7 is a flow chart showing the operation of the second embodiment (part 1); and

FIG. 8 is a flow chart showing the operation of the second embodiment (part 2).

### DESCRIPTION OF THE PREFERRED EMBODIMENTS

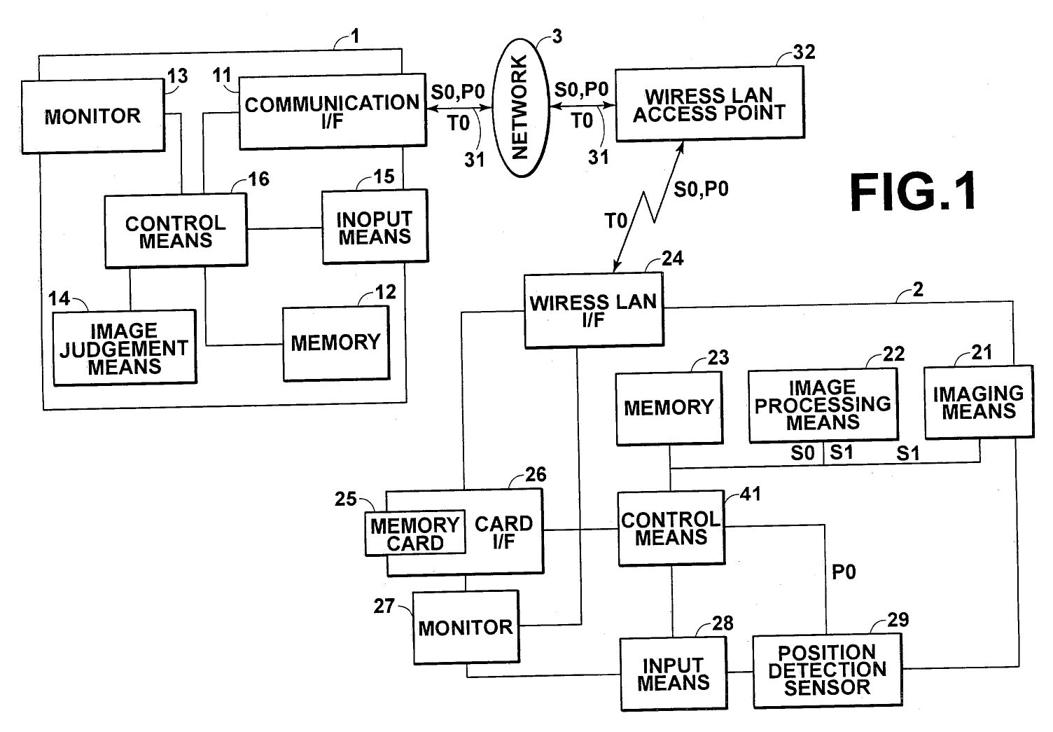

Hereinafter, embodiments of the present invention will be explained with reference to the accompanying drawings. FIG. 1 is a block diagram showing a configuration of an image storage management system comprising an image management apparatus and an imaging apparatus according to a first embodiment of the present invention. As shown in FIG. 1, the image storage management system in the first embodiment carries out data communication between an image management apparatus 1 and a digital camera 2 via a network 3 including a wireless LAN. In this embodiment, a foreman of a construction site carries the digital camera 2, and photographs predetermined spots in the construction site by the digital camera 2 for obtaining image data sets S0 representing the spots.

The image management apparatus 1 is operated by an administrator thereof, and the image management apparatus 1 comprises a communication interface 11, a memory 12, a monitor 13, image judgment means 14, input means 15, and control means 16. The communication interface 11 carries out communication via the network 3. The memory 12 stores various kinds of information and a program for the operation of the image management apparatus 1. The monitor 13 displays the image data sets S0 sent via the network 3 and the various kinds of information. The image judgment means 14 judges whether or not the respective image data sets S0 have been sent from the digital camera 2. The input means 15 comprises a keyboard and a mouse for carrying out various kinds of input. The control means 16 controls the communication interface 11, the memory 12, the monitor 13, the image judgment means 14, and the input means 15.

The communication interface 11 receives the image data sets S0 sent from the digital camera 2 via the network 3 comprising a wired LAN 31 and a wireless LAN access point 32. The communication interface 11 also sends photography instruction information T0 stored in the memory 12 to the digital camera 2 via the network 3.

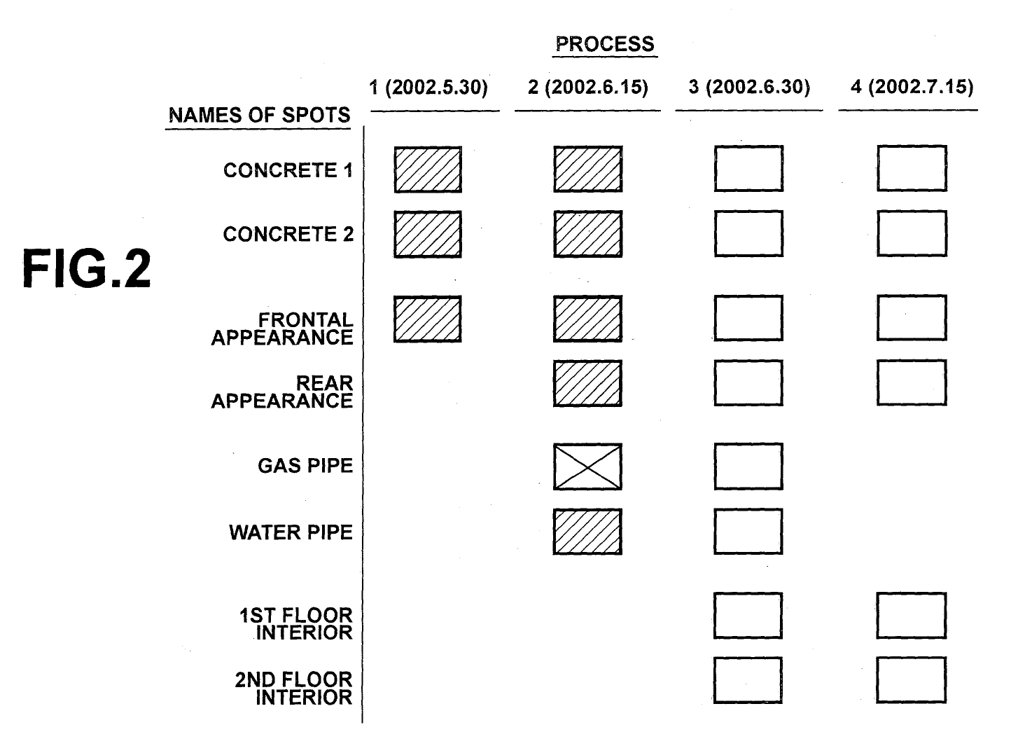

The memory 12 stores the image data sets S0 sent from the digital camera 2, site management information G0, and the program that controls the image management apparatus 1. FIG. 2 shows an example of the site management information G0. As shown in FIG. 2, the site management information G0 comprises a two-dimensional diagram representing sketches of images of the predetermined spots in the construction site and management expiration dates (hereinafter referred to as deadlines) of construction processes. In FIG. 2, the horizontal axis represents process numbers of the respective deadlines and the vertical axis represents the names of the spots that need to be supervised at the respective processes. For example, in the process number 2 whose deadline is Jun. 15, 2002, the site management information G0 indicates that images of Concrete 1, Concrete 2, frontal appearance, rear appearance, a gas pipe, and a water pipe are necessary for management. In FIG. 2, hatched images represent images whose photography has been completed.

For the process number 2, in order to cause the foreman having the digital camera 2 to photograph the necessary spots, the site management information is read several days before the corresponding deadline from the memory 12 as the photography instruction information T0 wherein the sketches of Concrete 1, Concrete 2, the frontal appearance, the rear appearance, the gas pipe, and the water pipe are included together with the names of the spots and the process number (number 2, in this case). The photography instruction information T0 is sent from the communication interface 11 to the digital camera 2 via the network 3.

When the photography instruction information T0 is sent to the digital camera 2, a position of the digital camera 2 is confirmed as will be explained later. The photography instruction information T0 is sent to the digital camera 2 positioned in a place where photography of the predetermined spots is possible. In this manner, the photography instruction information T0 can be prevented from being sent to a digital camera located at a different site. The position of the digital camera 2 can be confirmed by the control means 16, based on position information P0 sent from the digital camera 2 as will be explained later.

The monitor 13 displays the various kinds of information such as a management image comprising the image data sets S0 sent from the digital camera 2 attached to the site management information G0.

The image judgment means 14 judges whether or not the respective subject images necessary in each of the processes are lacking, based on the photography instruction information T0. In the case where a portion of the subject images is lacking, the image judgment means 14 sends to the digital camera 2 the photography instruction information T0 corresponding to the lacking image or images as unsent image information.

Even in the case where all the subject images are available, if a portion of the subject images does not have a predetermined quality due to camera shake, inappropriate focus, or underexposure, the construction site cannot be supervised correctly. Therefore, the image judgment means 14 judges whether or not the respective images have a predetermined quality. In the case where a portion of the images does not have the quality, the image or images are judged to be lacking. Therefore, the image judgment means 14 sends re-transmission instruction information to the digital camera 2 for causing the digital camera 2 to send the image data set or sets S0 corresponding to the lacking image or images.

In this case, information indicating that the image or images represented by the image data set or sets S0 do not have the predetermined quality is preferably sent to the digital camera 2. Although the management image can be displayed without re-transmission of the image or images that do not have the predetermined quality, the image or images that do not have the quality are displayed with an [symbol] in the management image. For example, if the image of the gas pipe in the process number 2 does not have the predetermined quality as shown in FIG. 2, the corresponding image in the management image is crossed out.

The digital camera 2 comprises imaging means 21, image processing means 22, a memory 23, a wireless LAN interface 24, a card interface 26, a monitor 27, input means 28, a position detection sensor 29, and control means 41. The imaging means 21 obtains image data sets S1 representing the images of the spots through photography thereof. The image processing means 22 carries out image processing on the image data sets S1 to generate the image data sets S0. The memory 23 stores the image data sets S0, the photography instruction information T0 sent from the image management apparatus 1, and a program and the like for controlling the digital camera 2. The wireless LAN interface 24 carries out communication using the wireless LAN. The card interface 26 is used to set a memory card 25 for recording the image data sets S0. The monitor 27 displays various kinds of information at the time of photography. The input means 28 comprises ten keys, buttons, and the like for operating the digital camera 2 and for inputting information. The position detection sensor 29 generates the position information P0 regarding the digital camera 2 by receiving a positioning signal from GPS satellites. The control means 41 controls the imaging means 21, the image processing means 22, the memory 23, the wireless LAN interface 24, the card interface 26, the monitor 27, the input means 28, and the position detection sensor 29.

The imaging means 21 comprises a lens, a zoom mechanism, a shutter, and CCDs. The imaging means 21 obtains the image data sets S1 representing the images of the spots by photographing the spots as the subjects with use of the shutter.

The image processing means 22 carries out the image processing such as gradation conversion processing, density conversion processing, color correction processing, and sharpness processing on the image data sets S1, and obtains the image data sets S0 to be sent to the image management apparatus 1.

The wireless LAN interface 24 carries out the communication according to an IEEE standard with the wireless LAN access point 32 of the network 3, for sending the image data sets S0 to the wireless LAN access point 32. The wireless LAN interface 24 also receives the photography instruction information T0 sent from the image management apparatus 1 via the wireless LAN access point 32. The IEEE standard is preferably IEEE802.11a or IEEE802.11b, for example. The standard IEEE802.11b is a mainstream standard using a 2.4 GHz band and having a maximum of 11 Mbps transfer speed. The standard IEEE802.11a uses a 5.0 GHz band and realizes an transfer speed of up to 54 Mbps. In addition, IEEE802.11g using a 2.4 GHz band and having a maximum transfer speed of 54 Mbps has been proposed.

The position detection sensor 29 receives the positioning signal from the GPS satellites and generates the position information P0 of the digital camera 2. The position information P0 refers to information representing the latitude and the longitude of the position of the digital camera 2.

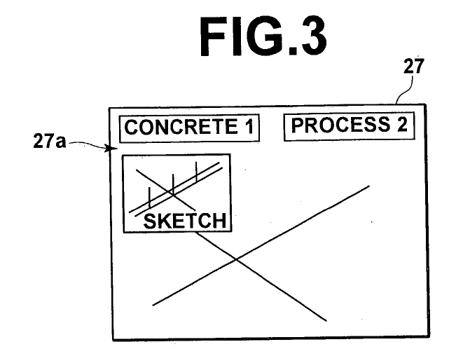

When the digital camera 2 receives the photography instruction information T0 from the image management apparatus 1, a photography instruction image is displayed on the monitor 27. FIG. 3 shows the photography instruction image displayed on the monitor 27. As shown in FIG. 3, a photography instruction image 27a displayed on the monitor 27 includes one of the sketches, the name of the corresponding one of the spots (Concrete 1, in this case), and one of the process numbers (number 2, in this case).

The foreman having the digital camera 2 can photograph each of the necessary spots in each of the processes, based on the photography instruction image 27a. Each of the processes has the plurality of spots to be photographed. Therefore, the sketches and the names of the spots are displayed on the monitor 27 in predetermined order. For example, the sketches and the names of the spots are displayed in the same order as in the vertical axis of the site management information G0. Photography of a subsequent one of the spots may be carried out sequentially after photography of one of the spots. Alternatively, the foreman (the photographer) may carry out photography in order of his/her preference by switching the sketches and the names of the spots by operating the input means 28.

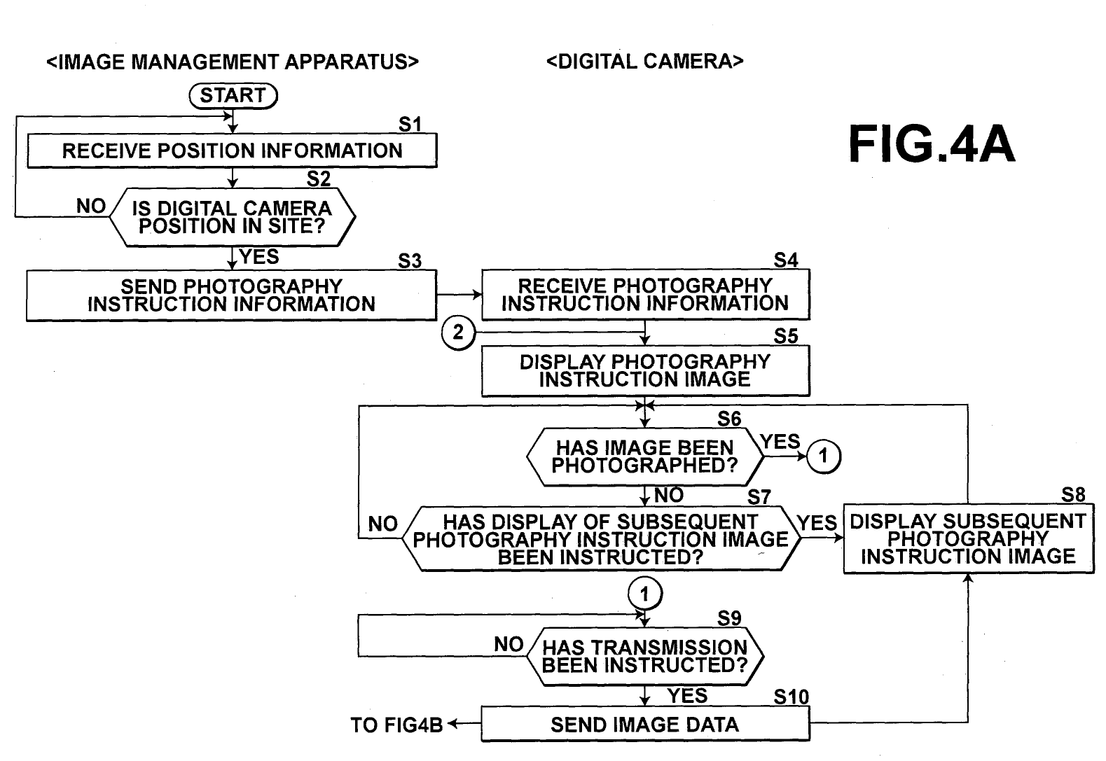

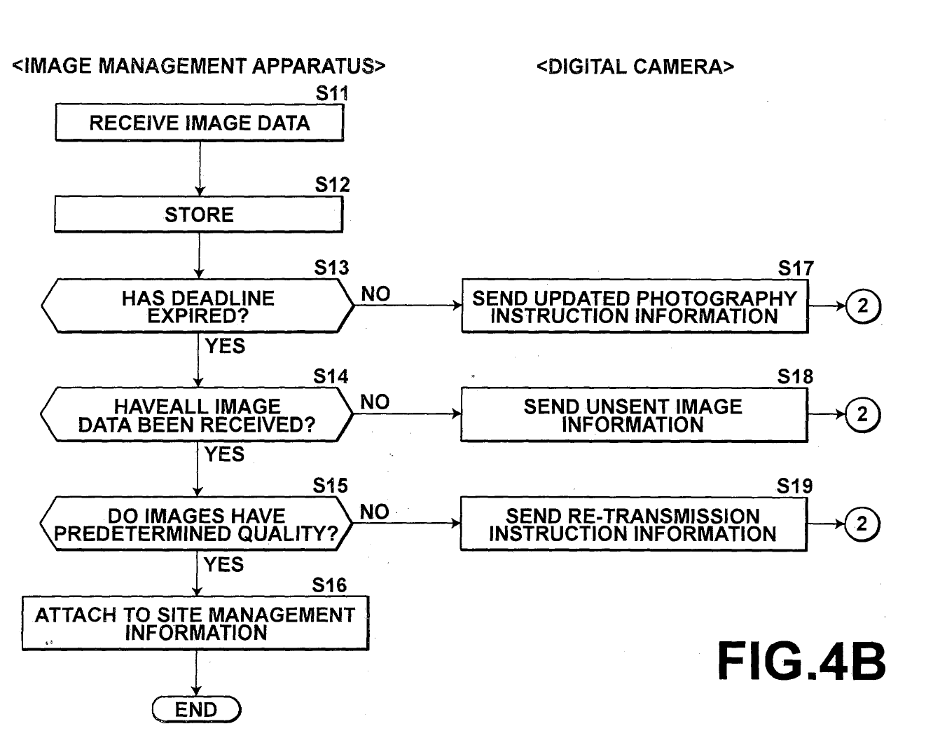

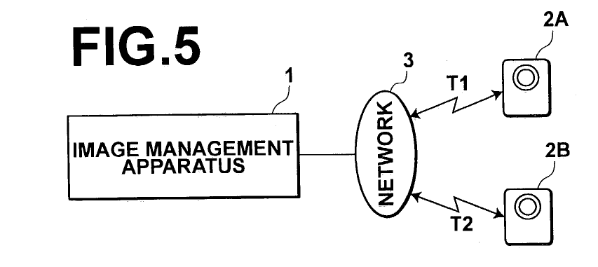

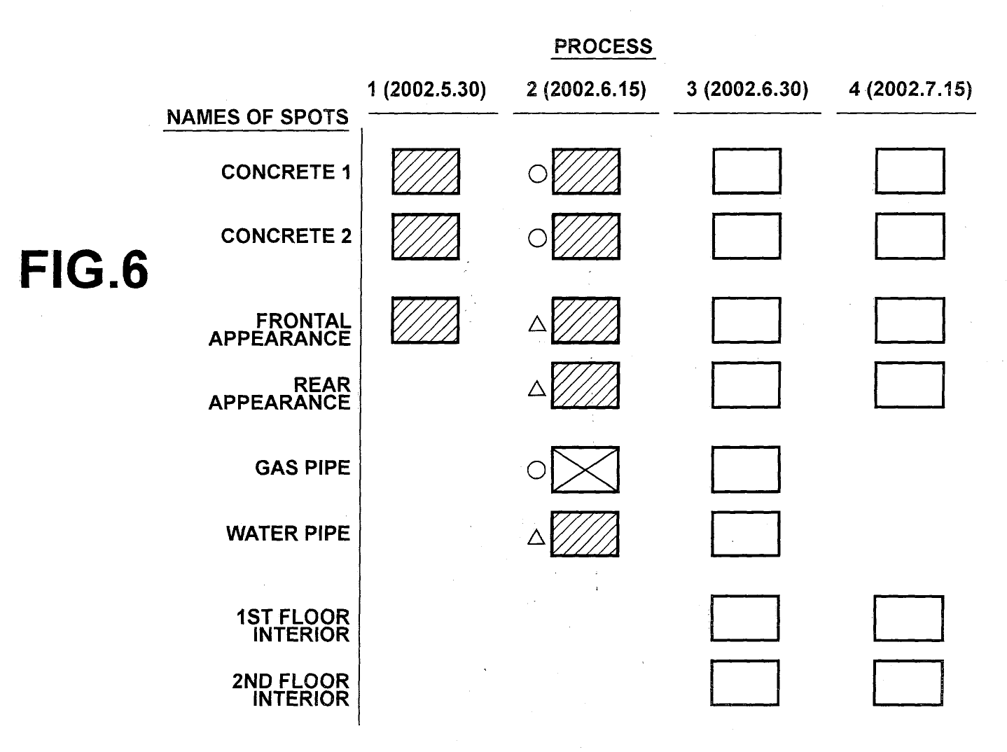

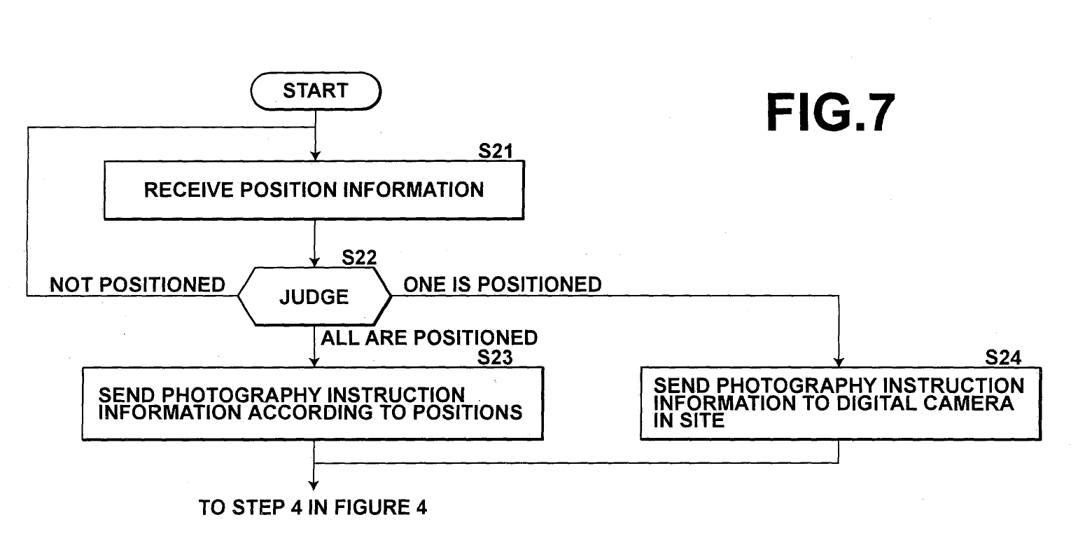

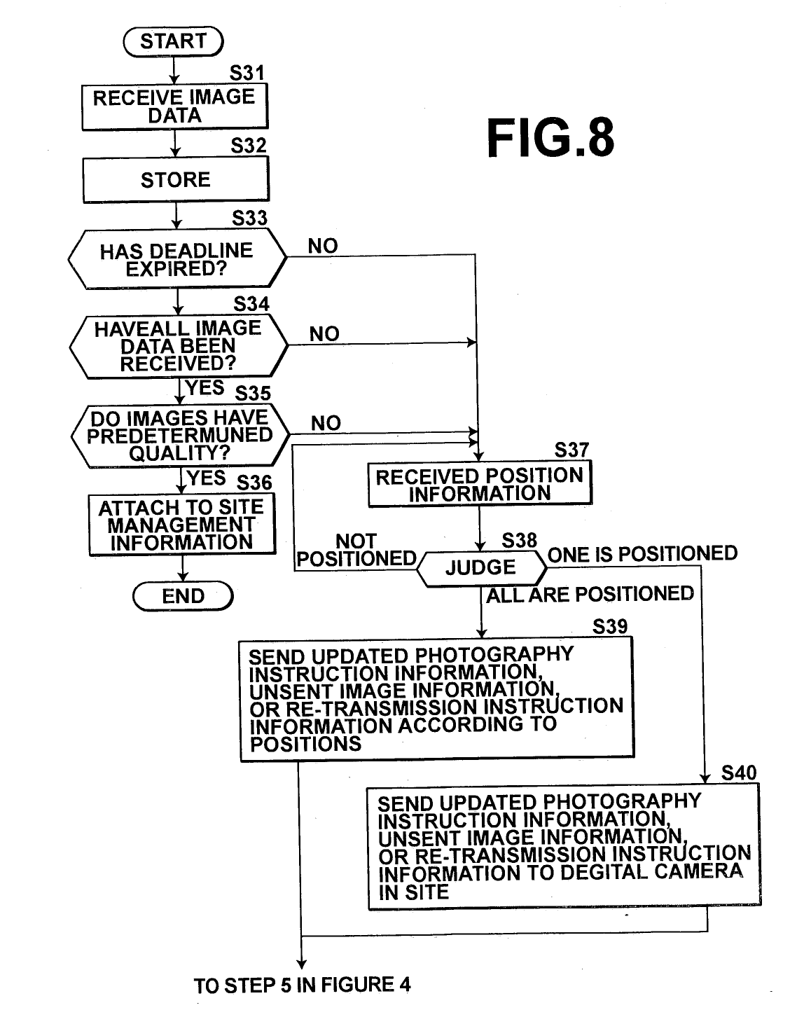

The operation of the first embodiment will be explained next. FIG. 4A and FIG. 4B show a flow chart illustrating the operation in the first embodiment. The image management apparatus 1 receives the position information P0 from the digital camera 2 (Step S1). Whether or not the digital camera 2 is positioned at the construction site to be photographed is then judged (Step S2). If a result at Step S2 is negative, the process returns to Step S1 to repeat the procedures from Step S1 to Step S2.

If the result at Step S2 is affirmative, the photography instruction information T0 corresponding to one of the processes to be photographed is read from the memory 12 and sent to the digital camera 2 (Step S3).

The digital camera 2 receives the photography instruction information T0 (Step S4). The photography instruction image 27a is then displayed on the monitor 27 according to the photography instruction information T0 (Step S5). Whether or not photography has been carried out is then judged (Step S6). If a result at Step S6 is negative, it is judged that whether or not instruction of display of the photography instruction image 27a for the subsequent spot is input from the input means 28 (Step S7). If a result at Step S7 is negative, the process returns to Step S6 to repeat the procedures from Step S6 to Step S7. If the result at Step S7 is affirmative, the photography instruction image 27a of the subsequent spot is displayed (Step S8), and the process returns to Step S6.

If the result at Step S6 is affirmative, monitoring starts for judging whether or not an instruction of data transmission is input from the input means 28 (Step S9). If a result at Step S9 becomes affirmative, the image data set S0 obtained by photography of the spot is sent to the image management apparatus 1 via the wireless LAN access point 32 (Step S10).

In the digital camera 2, the process returns to Step S8 after Step S10, and the photography instruction image 27a of the subsequent spot is displayed to return to Step S6.

In the image management apparatus 1, the image data set S0 sent from the digital camera 2 is received (Step S11), and stored in the memory 12 (Step S12). Whether or not the deadline has passed is then judged for the process regarding which the photography instruction information T0 was sent (Step S13). If a result at Step S13 is affirmative, whether or not the image data sets S0 have been received for all the spots in the process is judged (Step S14). If a result at Step S14 is affirmative, whether or not the image data sets S0 have the predetermined quality is judged for all the spots in the process (Step S15). If a result at Step S15 is affirmative, the images represented by the image data sets S0 for the process are attached to the site management information G0 (Step S16) to end the operation.

In this manner, the management apparatus 1 can display the management image including the site management information G0 on the monitor 13, and the administrator of the image management apparatus 1 can supervise the process regarding which the photography instruction information T0 was sent to the digital camera 2, based on the management image.

If the result at Step S13 is negative, the photography instruction information T0 is updated and sent to the digital camera 2 (Step S17). The process returns to Step S5 for display of the photography instruction image for further photography. The updated photography information T0 does not include the sketches and the names of the spots corresponding to the image data sets S0 that have been sent. By sending the updated photography instruction information T0 to the digital camera 2, the foreman having the digital camera 2 is prevented from reobtaining the image data sets S0 that have been sent, and the foreman can carry out efficient photography.

If the result at Step S14 is negative, the unsent image information is sent to the digital camera 2 for representing the type of the spot or spots regarding which the image data set or sets S0 have not been sent (Step S18), and the process returns to Step S5 for display of the photography instruction image corresponding to the unsent image information.

If the result at Step S15 is negative, the re-transmission instruction information is sent to the digital camera 2 for prompting re-transmission of the image data set or sets S0 that do not have the predetermined quality (Step S19). The process then returns to Step S5 for display of the photography instruction image corresponding to the re-transmission instruction information.

As has been described above, according to the first embodiment, the photography instruction information T0 representing the spots to be photographed is sent to the digital camera 2. Therefore, installation of digital cameras at all the spots becomes unnecessary. In this manner, photography can be carried out by the foreman for all the spots in the construction site, for obtaining the image data sets S0 with less equipment investment. The foreman having the digital camera 2 does not need to memorize all the spots to be photographed, and simply carries out photography according to the photography instruction information T0. In this manner, a workload of the foreman can be reduced.

Furthermore, by exchanging the photography instruction information T0 and the image data sets S0 via the network 3 using the wireless LAN, the image data sets S0 obtained at the site can be sent immediately to the image management apparatus 1 wherein the site management information G0 attached with the image data sets S0 is generated.

In the case where a portion of the image data sets S0 has not been received for some of the spots or in the case where a portion of the images represented by the image data sets S0 does not have the predetermined quality although the image data sets have been received, the unsent image information or the re-transmission instruction information is sent to the digital camera 2. Therefore, the digital camera 2 can obtain all the image data sets S0 corresponding to the photography instruction information T0 by photography of the spot or spots according to the unsent image information or the re-transmission instruction information. In this manner, the image management apparatus 1 can supervise the construction site based on all the images corresponding to the photography instruction information T0 in the process.

Since the photography instruction information T0 includes the sketches and the names of the spots for specifying the spots to be photographed, the foreman can easily know where the spots are located. As a result, the foreman can easily obtain the image data sets S0 corresponding to the photography instruction information T0.

Since the position of the digital camera 2 is detected based on the position information P0 sent from the digital camera 2, the image management apparatus 1 can easily know where the digital camera 2 is positioned. In this manner, the photography instruction information T0 is sent only to the digital camera 2 located at the construction site to be photographed, in the case where a plurality of digital cameras are used for site management. Therefore, the foreman can efficiently photograph the spots and obtains the image data sets S0.

A second embodiment of the present invention will be explained next. FIG. 5 is a block diagram showing a configuration of an image storage management system according to the second embodiment of the present invention. In the second embodiment, the same elements as in the first embodiment have the same reference numbers, and detailed explanations thereof will be omitted. As shown in FIG. 5, the image storage management system in the second embodiment causes a plurality of digital cameras 2 (two cameras in this case, and hereinafter referred to as digital cameras 2A and 2B) to photograph the spots by sending the photography instruction information from the image management apparatus 1.

In the image management apparatus 1, as in the first embodiment, the photography instruction information T0 is read from a memory 12. Based on the positions of the digital cameras 2A and 2B, the photography instruction information (hereinafter referred to as photography instruction information T1 and T2) is sent to the digital cameras 2A and 2B for photography of the spots close to their respective positions.

More specifically, in the case where the digital camera 2A is positioned close to Concrete 1, Concrete 2, and the gas pipe as shown in FIG. 6, the photography instruction information T1 is sent to the digital camera 2A for causing the digital camera 2A to photograph Concrete 1, Concrete 2, and the gas pipe shown with circles in FIG. 6. The photography instruction information T1 includes the sketches of Concrete 1, Concrete 2, and the gas pipe, the names of the spots, and the corresponding process number.

In the case where the digital camera 2B is positioned close to the frontal appearance, the rear appearance, and the water pipe (shown with triangles in FIG. 6), the photography instruction information T2 is sent to the digital camera 2B for causing the digital camera 2B to photograph these spots. The photography instruction information T2 includes the sketches of the frontal appearance, the rear appearance, and the water pipe, the names of the spots, and the corresponding process number.

The positions of the digital cameras 2A and 2B are judged based on the position information (hereinafter referred to as position information P1 and P2) sent respectively from the digital cameras 2A and 2B.

The operation of the second embodiment will be explained next. FIG. 7 is a flow chart showing the operation of the second embodiment. The image management apparatus 1 receives the position information P1 and P2 sent from the digital cameras 2A and 2B (Step S21). The positions of the digital cameras 2A and 2B are then judged (Step S22). In the case where all the digital cameras 2A and 2b have been judged to be positioned in the construction site, the photography instruction information T1 and T2 corresponding to the positions of the digital cameras 2A and 2B is generated and sent to the digital cameras 2A and 2B (Step S23).

In the case where only either one of the digital cameras 2A and 2B has been judged to be positioned in the site, the photography instruction information T0 is sent to the camera at the site (Step S24).

In the case where neither the digital camera 2A nor the digital camera 2B have been judged to be positioned at the site, the process returns to Step s21 to repeat the procedures from Step S21 to Step S22.

The digital cameras 2A and 2B that received the photography instruction information T1 and T2, or either one of the digital cameras that received the photography instruction information T0, carry out the procedures from Step S4 to Step S10 in the first embodiment, and the image data sets S0 obtained by photography are sent to the image management apparatus 1.

FIG. 8 is a flow chart showing the process carried out in the image management apparatus 1 after the image data sets S0 are sent thereto. The image data sets S0 sent from the digital cameras 2A and 2B are received (Step S31), and stored in the memory 12 (Step S32). Whether or not the deadline has expired is then judged for the process regarding which the photography instruction information T1 and T2 or the photography instruction information T0 was sent (Step S33). If a result at Step S33 is affirmative, whether or not the image data sets S0 have been received for all the spots in the process is judged (Step S34). If a result at Step S34 is affirmative, whether or not the image data sets S0 have the predetermined quality is judged for all the spots in the process (Step S35). If a result at Step S35 is affirmative, the images represented by the image data sets S0 for the process are attached to the site management information G0 (Step S36) to end the operation.

In this manner, the image management apparatus 1 supervises the process regarding which the photography instruction information T1 and T2 or the photography instruction information T0 was sent to the digital camera or cameras by displaying the management image including the site management information G0 on the monitor 13.

If the result at Step S33, Step S34, or Step S35 is negative, the position information P1 and P2 sent from the digital cameras 2A and 2B is received (Step S37), and the positions of the digital cameras 2A and 2B are judged (Step S38). In the case where all the digital cameras 2A and 2B have been judged to be positioned in the site, the updated photography instruction information, the unsent image information, or the re-transmission instruction information is sent to the digital cameras 2A and 2B as in the first embodiment, according to the positions of the digital cameras (Step S39). The process then returns to Step S5 in the first embodiment, for display of the photography instruction images corresponding to the updated photography instruction information, the unsent image information, or the re-transmission instruction information on the digital cameras.

The updated photography instruction information refers to the photography instruction information T1 and T2 generated again in consideration of movement of the digital cameras 2A and 2B, based on the position information P1 and P2 sent from the digital cameras 2A and 2B.

In the case where only either one of the digital cameras has been judged to be positioned at the site, the updated photography instruction information, the unsent image information, or the re-transmission instruction information is sent to the digital camera 2A or 2B at the site (Step S40). The process then returns to Step S5 in the first embodiment, for display of the photograph instruction image corresponding to the updated photography instruction information, the unsent image information, or the re-transmission instruction information on the digital camera.

As has been described above, in the second embodiment, the positions of the digital cameras 2A and 2B are detected and the photography instruction information T1 and T2 is sent thereto, for causing the carriers of the digital cameras to respectively carry out photography of the closer spots. Therefore, the carriers of the digital cameras 2A and 2B can photograph the spots and can obtain the image data sets with efficiency.

In the first and second embodiments described above, each of the image data sets S0 is sent to the image management apparatus 1 by inputting the transmission instruction regarding the image data set S0 from the input means 28. However, each of the image data sets S0 may be sent immediately after photography.

In the first and second embodiments described above, each of the image data sets S0 is sent to the image management apparatus 1 every time the photography is carried out on the corresponding spot. However, all the image data sets S0 may be sent to the image management apparatus 1 at once after photography in all the spots. In this case, the transmission instruction may be input from the input means 28. Alternatively, the image data sets S0 may be sent immediately to the image management apparatus 1 without the transmission instruction, after all the image data sets S0 become available.

In the first and second embodiments described above, the image data sets S0 are sent to the image management apparatus 1 via the wireless LAN. However, the image data sets S0 may be stored in the memory card 25 so that the image management apparatus 1 can later read the image data sets S0 from the memory card 25 to generate the site management information G0.

In the first and second embodiments described above, the image data sets S0 obtained by photography are sent to the image management apparatus 1. However, the control means 41 of the digital camera 2 may generate thumbnail image data sets representing thumbnail images of the images represented by the image data sets S0 so that the thumbnail image data sets can be sent to the image management apparatus 1 instead of the image data sets S0. In this case, the image data sets S0 are recorded in the memory card 25 by the digital camera 2, and input later to the image management apparatus 1.

In this case, in the image management apparatus 1, the site management information G0 is generated temporarily based on the thumbnail image data sets. In the site management information G0, resolution of the images included therein is low, since the site management information G0 was not generated from the image data sets S0. However, the content of the images can be recognized to some degree. The actual site management information G0 is generated from the image data sets S0 that are read later from the memory card 25.

In the first and second embodiments described above, the sketches are included in the photography instruction information T0. However, the photography instruction information T0 excluding the sketches may be sent from the image management apparatus 1 to the digital camera 2. In this case, the photography instruction image includes only the names of the spots and the corresponding process number.

In the first embodiment, the memory 23 in the digital camera 2 may store the sketches, the names of the spots, and the process numbers so that information representing only the process number that requires photography can be sent from the image management apparatus 1 to the digital camera 2. In this case, the digital camera 2 reads the sketches, the names of the spots, and the process number from the memory 23 according to the process number, and displays the photography instruction image generated therefrom.

In the second embodiment, the memories 23 of the digital cameras 2A and 2B may store the sketches, the names of the spots, and the process numbers so that the image management apparatus 1 can send to the digital cameras 2A and 2B only information representing the process number that requires photography and the names of the spots corresponding to the positions of the digital cameras 2A and 2B. In this case, the digital cameras 2A and 2B reads from the memories 23 the sketches, the names of the spots, and the process number for display of the photography instruction images on the monitors 27, based on the information sent thereto.

In the first and second embodiments described above, the photography instruction information T0 includes the names of all the spots in the corresponding process. However, for causing the digital camera 2 to photograph only one of the spots in the process, the photography instruction information T0 may include only the sketch and the name of the spot thereof. In this case, the digital camera 2 photographs only the spot, and sends the image data set S0 to the image management apparatus 1. The image management apparatus 1 receives the image data set S0 and sequentially sends the photography instruction information T0 to the digital camera 2 for causing the digital camera 2 to photograph a subsequent one of the spots. In the digital camera 2, the sketch and the name of the subsequent spot are displayed as the photography instruction image on the monitor 27. By repeating reception and transmission of the image data set S0 and the photography instruction information T0, all the image data sets S0 of all the spots in the process can be sent from the digital camera 2 to the image management apparatus 1.

In the first and second embodiments, the image data sets S0 are sent from the digital camera 2 via the wireless LAN. However, the image data sets S0 may be sent from the digital camera 2 by using a short range communication standard such as Bluetooth or a cellular phone network adopting a W-CDMA method or the like.

In the first and second embodiments above, the positions of the digital cameras 2, 2A, and 2B are detected based on the position information P0, P1, and P2 sent therefrom. However, each of the positions maybe detected based on where the wireless LAN access point 32 used for communication by the corresponding digital camera is located.

In the first and second embodiments described above, the photography instruction information T0 is sent to the digital cameras 2, 2A, and 2B for photography of the spots in the construction site. However, the present invention can be applied to a game such as an electronic image stamp rally wherein images of predetermined spots are collected by a large number of people.

In this case, the photography instruction information T0 represents subjects to be photographed at a predetermined site with deadlines of photography. In the case where all the subject images have been collected before the deadlines at respective spots, the image management apparatus issues a certificate to promote an incentive of each participant.

The present invention can also be applied to a game wherein photography instruction information T0 representing a subject to be photographed and a deadline is sent to a digital camera of each participant and a participant is declared a winner if the participant has sent an image data set earlier than any of the other participants. In such a game, an owner of a digital camera having the best image quality may be registered with the image management apparatus and the owner is notified to the other participants.

What is claimed is:

1. An image management apparatus comprising:
photography instruction information storage means for storing photography instruction information that indicates a subject to be photographed;
communication means for sending the photography instruction information to an imaging apparatus via a wireless communication network and for receiving information transmitted via the wireless communication network;
input means for receiving an input of image data obtained by the imaging apparatus according to the photography instruction information; and
storage means for storing the image data.

2. An image management apparatus as defined in claim 1, wherein the input means is means for receiving the input of the image data sent from the imaging apparatus via the wireless communication network.

3. An image management apparatus as defined in claim 1, further comprising communication control means for comparing the image data stored in the storage means with the photography instruction information stored in the photography instruction information storage means, and for controlling the communication means so that the photography instruction information corresponding to the image data is sent again to the imaging apparatus in the case where the storage means does not have the image data corresponding to the photography instruction information.

4. An image management apparatus as defined in claim 1, wherein the photography instruction information includes at least position information representing a position of the subject.

5. An image management apparatus as defined in claim 1 further comprising:
position detection means for detecting a position of the imaging apparatus, wherein
the communication control means controls the communication means to send to the imaging apparatus the photography instruction information corresponding to the position of the imaging apparatus.

6. An image management apparatus as defined in claim 1, wherein the photography instruction information includes a photography process representing the type of the subject to be photographed and a deadline for obtaining the image data.

7. An image management apparatus as defined in claim 1, wherein the wireless communication network refers to a wireless LAN communication network, or a cellular phone network, or a short range wireless communication network.

8. An imaging apparatus comprising:
imaging means for obtaining image data representing a subject by photography of the subject;
reception means for receiving the photography instruction information from the image management apparatus defined in claim 1;
display means for displaying information including the photography instruction information; and
storage means for storing the image data obtained by the imaging means according to the photography instruction information.

9. An imaging apparatus as defined in claim 8, further comprising transmission means for sending the image data stored in the storage means to the image management apparatus defined in claim 1 via the wireless communication network.

10. An imaging apparatus as defined in claim 9 further comprising:
position information obtaining means for obtaining position information representing a position of the imaging apparatus; and
transmission control means for controlling the transmission means to send the position information to the image management apparatus defined in claim 1.

11. An image storage management system comprising the image management apparatus defined in claim 1 and at least one imaging apparatus defined in claim 8.
